(19) United States
(12) Patent Application Publication
(10) Pub. No.: US 2003/0125180 A1
(43) Pub. Date: Jul. 3, 2003

(54) Apparatus and method for folding products

(76) Inventor: Gerald K. Sosalla, Appleton, WI (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/034,587

(22) Filed: Dec. 27, 2001

(51) Int. Cl. B31F 1/00

(52) U.S. Cl. 493/423

(57) ABSTRACT

The present invention includes a web folding apparatus that adheres the web to a belt. A gripping mechanism periodically grips the web from the belt. The action of the gripping ends the travel of the web on the belt and creates a first fold. The gripping mechanism releases the web to create a second fold. Consequently, a continuous web is folded into a zig-zag, continuous fold.

### BACKGROUND

Fibrous materials and fibrous composite materials are widely used as products, or as components of products, such as wet-wipes, towellettes, napkins, etc. because they can be manufactured inexpensively and made to have specific characteristics. These products can be manufactured so inexpensively that they can be viewed as disposable, as opposed to reusable. To form the products, the fibrous material is moistened and formed into continuous webs. The webs are further processed into individual wet-wipes. The processing includes cutting and folding the individual wipes into a stack for packaging. The stack is positioned in a package with a first wipe accessible to a user and upon removal of the first wipe, a second wipe is accessible, and so on to the last wipe. The processing of moist webs produces production challenges. For example, moisture from the wet-wipes may interfere with the production equipment, especially when the production equipment includes vacuum operated web folding equipment. Hygiene is important to when producing such products. Accordingly, it is necessary to keep a clean production environment.

One form of products produced from a web includes a stack of a continuous web with the individual products or sheets are separated by cross-direction perforations in the continuous web. When dispensed from the stack, the sheet being removed separates from the adjacent sheet in the stack at the perforation. Accordingly, it is desirable to provide a perforation that weakly joins the adjacent sheets so that the sheets easily separate when dispensed. However, the perforation must not be too weak so that the web separates during production. Conventional cross-direction, web-folding devices rely on a vacuum or mechanically actuated pincers to hold the web during a folding operation. But such folding devices require frequent maintenance and introduce potential product hygiene or system hygiene problems when folding wet webs.

### SUMMARY

The present invention is directed to a folding apparatus for folding a web into a stack. The folding apparatus includes a first folding unit and a second folding unit. The first folding unit, in an embodiment, includes a first pulley, a second pulley and a first belt supported by the first pulley and the second pulley, the smooth belt including a smooth surface releasably supporting the web and moving the web to a first fold of the stack. The second folding unit, in an embodiment, includes a third pulley, a fourth pulley, a second belt supported by the third pulley and the fourth pulley, and a gripper assembly on the second belt, the gripper assembly periodically gripping the web and moving the web to a second fold of the stack. The present invention adheres a portion of the web to the first belt to fold a first layer of the web stack. The present invention grips the web to fold a second layer of the web stack.

A method of the present invention includes releasably adhering the wet web to a belt, moving a first portion of the wet web to one side of a stack, gripping a second portion of the wet web off the belt, and moving the second portion of the wet web to a second side of the stack. In an embodiment, the method includes pressing the web against a smooth surface of the belt. In an embodiment, the method includes using a textured roller to press the web against the smooth belt. In an embodiment, the method includes gripping the second portion of the web off the smooth belt. In an embodiment, the method includes tucking a portion of the web into a gripping assembly. In an embodiment, the method includes providing a gripping assembly on a second belt, opening gripping assembly as the second belt travels in an arcuate path, and closing the gripping assembly as the second belt travels in an essentially linear path. In an embodiment, the method includes the second portion of the web away from the first belt to which the web is releasably adhered.

In an embodiment of the present invention, a web folding apparatus adheres a web to a belt. A gripping mechanism periodically grips the web from the belt. The action of the gripping ends the travel of the web on the belt and creates a first fold. The gripping mechanism releases the web to create a second fold. Consequently, a continuous web is folded into a zigzag, continuous fold.

Further embodiments of the present invention will be apparent to one of ordinary skill upon reading the present disclosure.

### BRIEF DESCRIPTION OF THE DRAWINGS

FIG. 1 is a schematic view of a product manufacturing device including a folding apparatus according to the present invention.

FIG. 2 is an enlarged schematic view of the folding apparatus according to the present invention.

FIG. 3 is an elevational view of the smooth belt portion of the folding apparatus according to the present invention.

FIG. 4 is an elevational view of the textured roller portion of the folding apparatus according to the present invention.

FIG. 5 is an enlarged view of the belt with gripping fingers of the folding apparatus according to the present invention.

FIG. 6 is a view illustrating the dimensions of an embodiment of the folding apparatus according to the present invention.

FIG. 7 is a view of a container into which a product stack created by the folding apparatus according to the present invention is positioned.

### DEFINITIONS

As used herein the terms “attached” and “bonded” both refer to joining, adhering, connecting, or the like of elements. The elements are considered to be bonded or/or attached together when they are bonded directly to each other or indirectly through intermediate elements to each other. This definition also applies to words of similar meaning.

As used herein, the term “comprise” and its derivatives are intended to be open ended terms that specify the presence of the stated features, elements, components, groups, integers, and/or steps, but do not exclude the presence of other, unstated features, elements, components, groups, integers, and/or steps. This definition also applies to words of similar meaning, for example, the terms “has” and “include” and their derivatives.

As used herein, the terms “elastic” and “elastomeric” and their derivatives refer to a property of a material by virtue of which the material tends to recover its original size and shape after removal of a force causing the material to deform.

As used herein, the term “layer” when used in a singular form may refer to a single unitary element or a plurality of elements.

As used herein the term “non-woven web” means a structure or a web of material that has been formed without use of weaving processes to produce a structure of individual fibers or threads, which are intermeshed, but not in an identifiable, repeating manner. Non-woven webs have been, in the past, formed by a variety of conventional processes such as, for example, meltblowing processes, spinbonding processes, film aperturing processes and staple fiber carding processes.

As used herein, the term “machine direction” or MD means the length of a material, fabric, or web in the direction in which it is produced. The term “cross-machine direction” or CD means the width of a material, fabric, or web i.e., a direction generally perpendicular to the MD.

Certain terminology will be used in the following description for convenience in reference only and will not be limiting. The words “up”, “down”, “right” and “left” will designate directions in the drawings to which reference is made. The words “in” and “out” will refer to directions toward and away from, respectively, the geometric center of the device and designated parts thereof. Such terminology will include derivatives and words of similar meaning.

### DETAILED DESCRIPTION OF THE EMBODIMENTS

In the following detailed description of the embodiments, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that process, electrical or mechanical changes may be made without departing from the scope of the present invention.

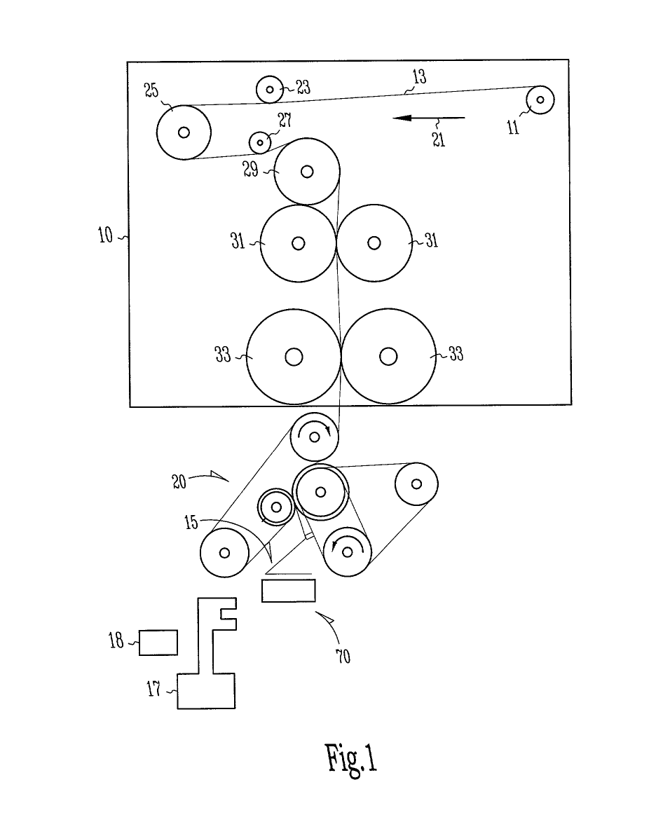

FIG. 1 shows a product source 10, a folding apparatus 20, a stack mover 17 and a container 18 for receiving a stack. Product source 10, in an embodiment, provides a web 13 to the folding apparatus 20. The folding apparatus 20 folds the web 13 into a stack 15. The stack mover 17 moves the stack 15 from the folding apparatus 20 to the container 18.

The product source 10 includes a web source roll 11 providing a web 13. In an embodiment, the web 13 is a fibrous web such as, for example, a nonwoven web of meltblown fibers, spunbond filaments, coform, a wet-laid fibers, air-laid fibers, a bonded carded fiber, or the like, as well as combinations thereof. In an embodiment, the web 13 is a paper product. Desirably, the web is a moistened or wet web. The web may be a single ply or may be composed of a material made up of multiple plies. In an embodiment, the web 13 includes components for making moist towelettes or wet-wipes. Web 13 may include a composite elastic material including an elastic fibrous web that can be a composite of elastomeric fiber and elastomeric meltblown fibers. The web of the present invention includes a basesheet of the composite elastic material and a liquid. The liquid can be any solution that can be absorbed into a web basesheet and may include any suitable components that provide the desired wiping properties. For example, the components may include water, emollients, surfactants, fragrances, preservatives, chelating agents, pH buffers or combinations thereof as are known to those skilled in the art. The liquid may also contain lotions and/or medicaments. The amount of liquid contained within the web may vary depending upon the type of material being used to manufacture or dispense the web, the type of liquid being used, the type of container being used to store a web stack, and the desired end use of the web. Generally, the web, in an embodiment, contains from about 150 to about 600 weight percent and preferably from about 250 to about 450 weight percent liquid based on the dry weight of the web for improved wiping. In a more preferred embodiment, the amount of liquid contained within the web is from about 300 to about 400 weight percent and desirably about 330 weight percent based on the dry weight of the web. If the amount of liquid is less than the above-identified ranges, the web can be too dry and may not adequately perform. If the amount of liquid is greater than the above-identified ranges, the web can be oversaturated and soggy and the liquid may undesirably pool in the bottom of the container.

The web of the present invention may include, but is not limited to, a unitary basesheet, a layered basesheet, or a basesheet laminate of at least two layers of material having the same or different physical properties. The different physical properties that a layer may provide by selecting the appropriate materials include softness, resiliency, strength, flexibility, integrity, toughness, absorbency, liquid retention, thickness, tear resistance, surface texture, drapability, hand, wettability, wicking ability and the like, and combinations thereof. In an embodiment, the materials used for the layered basesheet are configured to provide softness and flexibility while maintaining adequate strength, integrity and resiliency, particularly when wetted. For example, the web may include at least one layer of material, which is configured to provide strength and resilience to the web, and at least one other layer, which is configured to provide a soft, gentle wiping surface to the web. The web includes a soft layer on each side of a strong and resilient layer such that both exposed surfaces of the web provide a soft, gentle surface for contact with the skin. Other forms of the web for use as personal hygiene products would be known to those of skill in the art and may be used with the present invention.

The web 13 travels in the direction of arrow 21 generally parallel to the ground past a liquid dispensing pipe or bar 23 to a first feed roller 25. The liquid dispensing bar 23 downwardly dispenses a liquid to moisten the upwardly facing, essentially horizontal, top surface of the web 13. The first feed roller 25 reverses the direction of web 13, which travels essentially parallel to the ground, so that the web is essentially flipped over with the surface moistened by bar 23 is now facing downward. The web 13 now travels past a further liquid dispensing pipe or bar 27 to a second feed roller 29. The liquid dispensing bar 27 downwardly dispenses a liquid to moisten the upwardly facing, essentially horizontal, top surface of the web 13, which top surface is opposite the surface moistened by the first bar 23. Accordingly, the bars 23, 27 wet both planar surfaces of web 13. The second feed roller 29 alters the travel direction of web 13 so that it exits roller 29 in a direction essentially transverse to the web's initial travel direction. The web is now traveling toward the ground. In an embodiment, web 13 travels essentially vertically, transverse to ground. Web 13 travels between two drive rollers 31 that pull the web through the product source 10. Web 13 leaves the drive rollers 31 and travels between two drum dies 33 that perforate the web 13. The perforations 14 divide the web into segments or individual sheets for use by a consumer. The perforations 14 desirably weaken the web so that the consumer can remove one individual segment from the remaining web. However, the weakening of the web 13 due to the perforations 14 results in difficulties in folding the web 13 into a stack 15. The web 13, in an embodiment, is moist.

In an embodiment, each web segment is generally rectangular in shape and may have any suitable unfolded width and length. For example, the segment may have an unfolded length of from about 2.0 to about 80.0 centimeters and desirably from about 10.0 to about 27.0 centimeters, and an unfolded width of from about 2.0 to about 80.0 centimeters and desirably from about 10.0 to about 25.0 centimeters. Each individual segment is stacked one on top of the other to provide a stack of web segments suitable for pop-up type dispensing. Such folded configurations are known to those skilled in the art and include c-folded, v-folded, z-folded, quarter-folded configurations and the like. A preferred folded configuration is a continuous zigzag fold configuration. The stack of folded, continuous web segments are typically placed in an interior of a container, such as a plastic tub or flexible bag, to provide a package of wet-wipes for eventual sale to the consumer. The web includes a continuous strip of material, which has perforations separating individual web segments and which may be arranged in a stack for individual dispensing. In an embodiment, the zig-zag fold configuration folds at least a portion of an individual web segment back onto another portion of the web segment.

The above description of the product source 10 is but one embodiment of a structure for supplying a product web to the folding apparatus. It will be understood that other configurations of the elements of the product source 10 are within the scope of the present invention. One example of another product source includes merely supplying web 13 from the material source roll 11 to the folding apparatus. In another embodiment, the web 13 travels in a direction other than horizontal as it passes liquid dispensers, such as bars 23, 27. For example, the web 13 travels essentially vertically toward the folding apparatus 20 of the present invention. Liquid dispensers are positioned adjacent at least one planar side of the web 13. The dispensers wet the web on its planar surface. In an embodiment, dispensers are positioned on both planar sides of the web 13 and project the moistening agent essentially horizontally as the web passes the dispensers. In an embodiment, the web 13 is wet when stored on the source roll 11 and then supplied directly to the perforation drums 33.

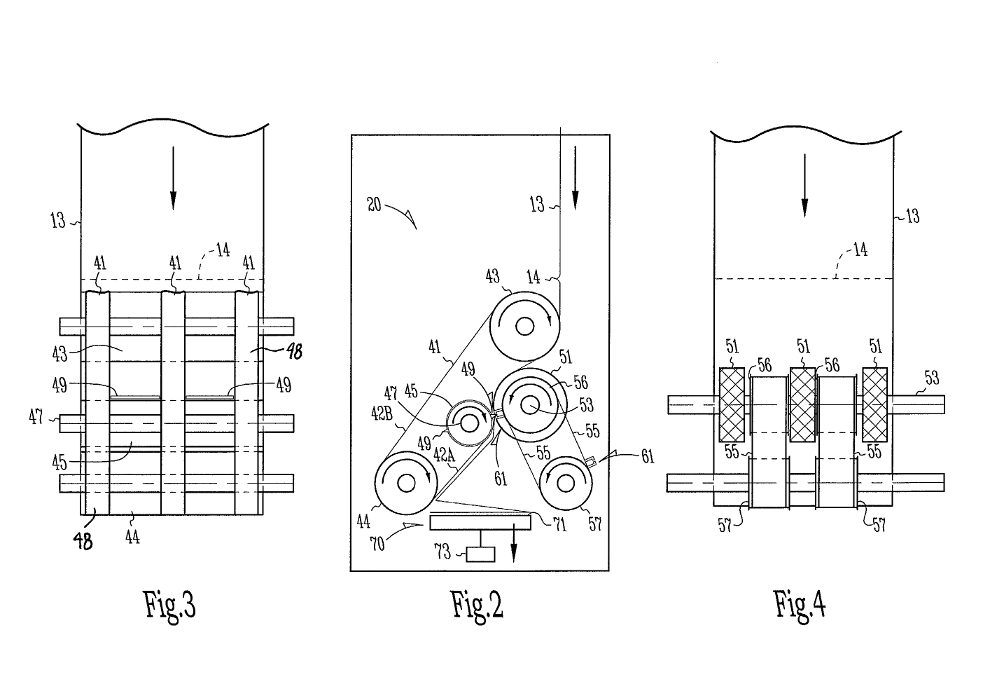

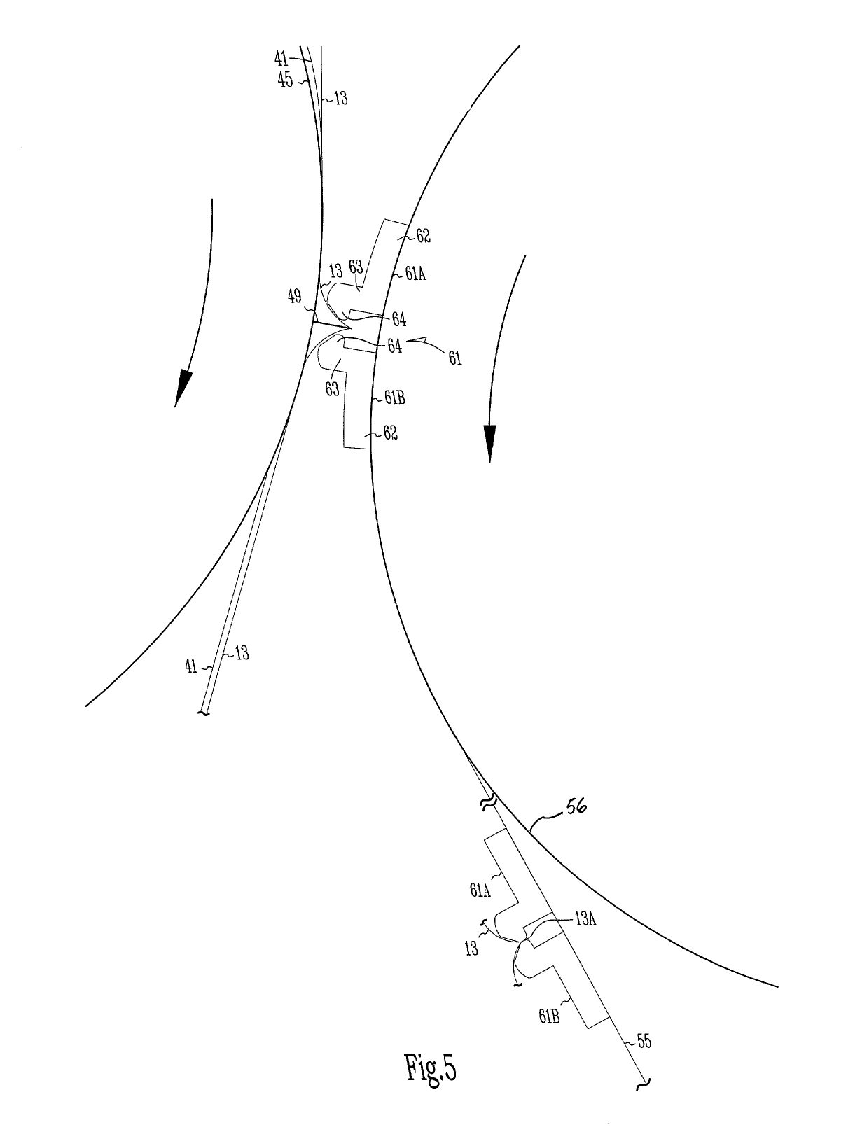

FIG. 2 shows the folding apparatus 20, which includes a first folding unit that has at least one, endless, first belt 41 supported on an upper pulley 43 and a lower pulley 44. The upper pulley is horizontally and vertically offset from the lower pulley 44. Accordingly, belt 41 travels on an inclined path between pulleys 43, 44. At least one of the pulleys 43, 44 drive the belt 41 in a clockwise direction. The first belt 41 includes an inner, first segment 42A and an outer, second segment 42B. A tensioning pulley 45 is positioned intermediate the two pulleys 43, 44 in contact with the inner segment 42A of the first belt 41 on the inner surface thereof. A portion of the inner segment 42A downstream of the tensioning pulley 45 is substantially parallel with the outer segment 42B. A shaft 47 supports the tensioning pulley 45 and at least one tucking finger or blade 49. In an embodiment, the tensioning pulley 45 is connected to the shaft 47 by bearings (not shown) that allow the pulley 45 to freely rotate relative to the shaft 47. In an embodiment, the blade 49 is fixed on the shaft 47. The blade 49 extends radially outwardly from the shaft 47 a greater distance than both the pulley 45 and the outer surface of the inner segment 42A of belt 41. The belt 41 has a smooth outward-facing surface 48 (FIG. 3), i.e., surface not in contact with pulleys 43, 45. The web 13 contacts the outward-facing surface 48 of belt 41 as the belt 41 travels around the upper pulley 43 or just after the web is past the upper pulley 43.

Folding apparatus 20 further includes a second folding unit that has at least one textured roller 51 positioned intermediate the upper pulley 43 and the tensioning pulley 45 and on the opposite side of the web 13 from the pulleys 43, 45. The textured roller 51 has a textured surface that is rougher than the outer, smooth surface 48 of the first belt 41. A shaft 53 rotatably supports the textured roller 51. In an embodiment, the roller 51 is supported by bearings that allow the textured roller 51 to freely rotate relative to the shaft 53. An endless, second belt 55 is supported by an upper pulley 56 on the shaft 53 and a lower pulley 57. The upper pulley 56 is horizontally and vertically offset from the lower pulley 57. Upper pulley 56 is fixed on shaft 53. The lower pulley 57 is generally horizontally aligned with the lower pulley 44. That is, the lowest point of the pulleys 44 and 57 are generally coplanar. The lower pulley 57 has a diameter that is less than the diameter of the textured roller 51. In an embodiment, the pulleys 56, 57 are about equal in diameter. The second belt 55 includes at least one gripping assembly 61. Each gripping assembly 61 extends outwardly from the belt 55. In an embodiment, the gripping assembly 61 extends essentially equal to the outer surface of the textured roller 51. In an embodiment, the gripping assembly 61 extends beyond the outer surface of the textured roller 51. In an embodiment, the gripping assembly 61 is recessed inwardly of the outer surface of the textured roller 51. The textured roller 51 urges or presses the web 13 against the outward, smooth surface 48 of belt 41. Specifically, the textured roller 51 presses web 13 against inward segment 42A of belt 41 such that the web 13 is sandwiched between the textured roller 51 and belt segment 42A.

The web 13 releasably adheres to the smooth belt 41 due to the greater surface area in contact with the smooth belt relative to the textured roller 51. More specifically, the web 13 has a greater negative pressure gradient on the smooth belt 41 than on the textured roller 51. When the web 13 is moist, then the moisture in the web adheres the web to the belt by creating a tension (negative pressure) on the belt. It is believed that the present invention may also work if the web is dry due to electrostatic charge on the web adhering the web to the smooth belt. Moreover, when the belt is pressed against the smooth belt 13, the phenomenon of a wet article adhering to a smooth surface resists moving the web off the belt 41 even with the belt 41 rotating around pulleys 43, 44. The forces adhering the web to the belt 41 must be overcome or removed to release the web 13 from the belt 41.

Folding apparatus 20 further includes a stacking table assembly 70 that is positioned intermediate the lower pulleys 44, 57. Stacking table assembly 70 has an essentially planar, horizontal support surface 71 on which the folded web 13 is received. An actuator 73 moves the surface 71 downwardly as the web 13 is received thereon. Thus, an upward facing surface that receives the next segment of the web is at a constant relationship relative to the lower pulleys 44, 57 and other elements of the folding apparatus 20. That is, when the web is first stacked on the support surface 71, the support surface is in the constant relationship with the rest of the folding apparatus. When, additional layers of the web 13 are stacked on top of each other, the uppermost layer of the stack is held at the constant relationship. In an embodiment, the uppermost one of the support surface 71 or stacked web layer is essentially coplanar relative to the lowest points of the lower pulleys 44, 57.

FIG. 3 shows the left hand side, relative to FIG. 2, of the folding apparatus 20 viewed generally along the web 13. This view generally shows the smooth belt, first unit of the folding apparatus 20. In the embodiment shown in FIG. 3, there are a plurality of first belts 41 and a plurality of blades 49. The plurality of belts 41 is spaced from each other. The blades 49 are positioned so that one blade is intermediate each pair of adjacent belts 41. The illustrated embodiment includes three belts 41 with two, horizontally-aligned blades 49. One blade 49 is in one of the interstices between the three belts 41. Each belt 41 has a smooth outward-facing surface 48, i.e., surface not in contact with pulleys 43, 45. The web 13 contacts the outward-facing surface 48 of belts 41 as the belts 41 travels around the upper pulley 43 or just after the web is past the upper pulley 43.

FIG. 4 shows the right hand side, relative to FIG. 2, of the folding apparatus 20 viewed generally along the web 13. This view generally shows the textured roller, second unit of the folding apparatus 20. In the embodiment shown in FIG. 4, shaft 53 supports a plurality of spaced apart textured rollers 51 and in each of the interstices between the textured rollers 53 a single belt 55 is supported on pulleys 56. The textured roller 51 contacts a side of the web 13 urging or pressing the web against the smooth belt 41. Both the textured roller 51 and pulley 45 are freely rotatable relative to their respective support shafts 47,53 and to each other. This allows the roller 51 and pulley 45 to account for any speed differentials in the speed of the web 13 on belt 41 and the speed of the gripping assembly 61 on belt 55 at the time the blade 49 contacts the web 13 and the gripping assembly 61 grips web portion 13A.

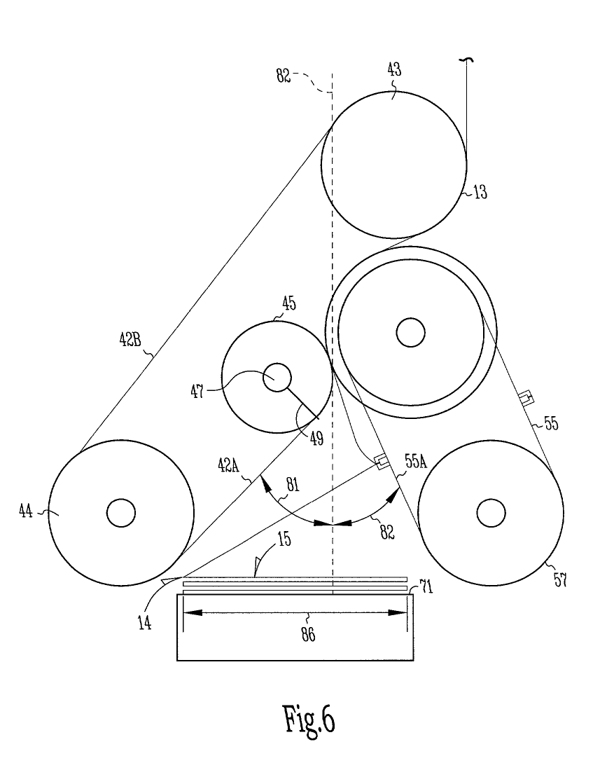

As discussed herein, the web 13 adheres to the smooth belt 41. FIG. 5 is an enlarged view of the gripping assemblies 61 and shows the action of the gripping assemblies 61 and tucking blades 49 to fold the continuous web 13 onto itself to create stack 15. Each gripping assembly 61 includes two jaws 61A, 61B that are fixed on belt 55. In an embodiment, that includes a plurality of belts 55, then a same number ofjaws 61A, 61B are positioned on each belt 55. The jaws 61A, 61B are illustrated as being mirror-images of each other. It will be recognized that the jaws 61A, 61B, in an embodiment, are not mirror-images of each other. For example, the lead jaw—respective to the first jaw to begin traveling around a pulley 56, 57 may have a lower profile or more angular profile to ensure proper release of or initial contact with the web 13. Each jaw 61A or 61B include a base 62 fixed to the belt 55. Each base 62 is elongated in the travel direction of the belt 55. Adjacent bases 62 are spaced from on another. A gripping head 63 extends upwardly from adjacent ends of each base 62. The gripping heads 63 are essentially normal to the belt 55. The gripping heads 63 each include a nose 64 that inclines outwardly as the nose 64 extends away from the facing, adjacent jaw 61A or 61B. As the belt 55 travels around the upper pulley 51, the gripping heads 63 and, more specifically noses 64, of adjacent jaws 61A and 61B move apart from each other. This action is due to the gripping heads 63 being essentially normal to the belt 55. When the belt 55 is in its planar travel segment intermediate the upper and lower pulleys 56, 57, the normal direction at the connecting points of the gripping heads 63 from the belt 55 are essentially parallel. The connecting points on the belt 55 are chosen so that the noses 64 close when the jaw assembly 61 is intermediate the pulleys 51, 57 so that the noses fix a portion 13A of web 13 therebetween. When the belt 55 is in its curved travel segment on either of the upper and lower pulleys 56, 57, the normal direction at the connecting points of the gripping heads 63 from the belts diverge from each other relative to the pulley. The connecting points on the belt 55 are chosen so that the noses 64 move apart and open when the jaw assembly 61 is on either of the pulleys 56, 57. Accordingly, through the use of the geometry of the travel path of belt 55, opening and closing action of the jaw noses 64 is achieved.

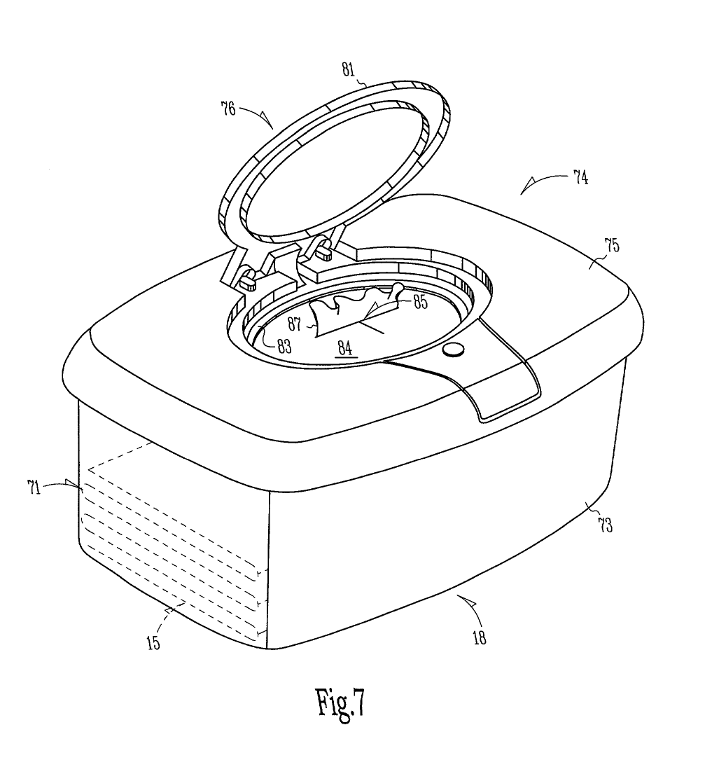

FIG. 6 shows the geometric relationship of the smooth belt unit 41, 43, 44 and the textured roller, gripping jaw unit 51, 55, 56, 57. The smooth belt inner segment 42A forms an angle 81 relative to a vertical axis 82 of the folding apparatus. The vertical axis 82 extends essentially vertical relative to ground. In an embodiment, vertical axis 82 extends perpendicular to the stacking table 71. Angle 81 is less than about 90 degrees. In an embodiment, angle 81 is in the range of about eighty degrees to about thirty degrees. In an embodiment, angle 81 is greater than forty degrees. In an embodiment, angle 81 is less than about sixty degrees. In one preferred embodiment of the invention, angle 81 is about fifty degrees. In one preferred embodiment of the invention, angle 81 is about forty-five degrees. An inner segment 55A of belt 55 forms an angle 83 relative to the vertical axis 82 of the folding apparatus. Angle 83 is less than about 90 degrees. In an embodiment, angle 83 is in the range of about eighty degrees to about thirty degrees. In an embodiment, angle 83 is greater than forty degrees. In an embodiment, angle 83 is less than about sixty degrees. In one preferred embodiment of the invention, angle 83 is about fifty degrees. In one preferred embodiment of the invention, angle 83 is about forty-five degrees. In other embodiments of the invention, the combined sum of the angles 81, 83 is about equal to ninety degrees. In other embodiments of the invention, the combined sum of the angles 81, 83 is less than about ninety degrees. In an embodiment, the combined sum of the angles 81, 83 is about eighty-five degrees. In an embodiment, the combined sum of the angles 81, 83 is about eighty degrees. In an embodiment, the combined sum of the angles 81, 83 is about seventy-five degrees. In an embodiment, the combined sum of the angles 81, 83 is about seventy degrees. In an embodiment, the combined sum of the angles 81, 83 is greater than fifty degrees. The length of the belt segment 42A is generally equal to the width 86 of stack 15. Thus, in an embodiment for an eight inch product, i.e., eight inches between perforations 14 on web 13, the length of the inner segment 42A between a release point at lower pulley 44 and adherence point at intermediate pulley 45 is approximately four inches. Moreover, the gripping assemblies 61 on the belt 55 are also spaced apart four inches minus the length of tucked portion 13A of web 13. Thus, the length of inner segment 42A is equal to the distance between gripping assemblies 61 minus the length of the tucked portion 13A of web 13, which is equal to length 86 minus the length of the tucked web portion 13A. In an embodiment, length 86 is equal to half the length (machine direction length) of web between perforations 14. Thus, the length between perforations is twice the width 86. In an embodiment, a single segment of web 13 extends from the left side of stack 15 to the right side and back on itself to form a portion of the stack 15. The length of the tucked web portion 13A depends on many variables in the current folding apparatus. For example, the variables include, but are not limited to, the amount of material of web 13 needed to securely hold the web in the gripping assemblies 61, the distance that the tucking blades 49 extend between open jaw noses 64, and the amount of web 13 that escapes from between jaw noses 64 as the noses close and blade 49 retracts.

It will be appreciated that it is desirable to have the perforations 14 not on the portion 13A of the web 13 that engages the gripping assemblies 61. In an embodiment, the perforations 14 are positioned on the left hand, smooth belt unit side of folding apparatus 20. Thus, the parts of the web 13 at and closely adjacent the perforations 14 are adhered to the smooth belt inner segment 42A during a folding and stacking operation. This decreases the likelihood that the web 13 will separate at the perforations 14 due to action of the gripping assemblies 61.

It will be understood that the specific geometries described herein may be scaled to fold other sizes of products. The size of the folded products depends, in part, on the dimensions of the desired product stack 15, the size of the product container, and specific application of the product, e.g., towelette, baby wipe, etc.

FIG. 7 shows an embodiment of a container 18 into which a stack 15 folded according to the teachings of the present invention is positioned. Stack 15 is a continuous, zig-zag stack 15 of consumer products such as wet-wipes, towelettes, moist napkins, and the like. The edge 71 of stack 15 represents a perforation whereat the shown stack 15 was separated from the continuous web 13. The stack 15 itself is continuous and folded back upon itself so that each of the subsequent perforations is vertically aligned generally at edge 71. Thus, in this embodiment of stack 15, the perforations are at one of the sides of the stack 15. In another embodiment, the perforations are positioned on a portion of the stack that was adhered to the belt 41. Container 18 includes an open-top tub 73 receiving stack 15 and a lid assembly 74 for closing the open-top of tub 73. Lid assembly 74 includes a main lid 75 and pop-up style dispenser 76 is recessed within the main lid 75. Dispenser 76 includes a lid 81 pivotably connected to the main lid 75, a base 82, and a rigid port 83 which surrounds a flexible, rubber-like sheet 84 having a dispensing opening 85 through which the wet wipes 87 are dispensed. The wet wipe 87 is an individual segment of web 13. The upper free edge of wipe 87 was at a perforation in the web.

In an embodiment, the present invention operates as follows. The web source 10 provides a continuous web 13 of product material through a series of rollers 25, and 29 past wetting bars 23, 27. Roller 29 aligns the web to extend thereafter essentially vertically. Drive rollers 31, thereafter, grip the web 13 and provide motive force to the web 13. Embossing rollers 33 emboss the web with a pattern, if not already on the web 13. Rollers 33 may further at a given interval perforate the continuous web 13 to such an extent that the web may be separated into individual sheets for consumer use at the perforations 14. However, the perforations 14 do not weaken the web to such an extent where the web 13 will separate into individual sheets (segments) during its subsequent folding into a stack 15. Web 13 comes into contact with upper roller 43 and its course is altered from its original travel direction, i.e., from a vertical path to a non-vertical path. The web 13 comes into contact with at least one textured roller 51 intermediate the pulleys 43, 45. The textured roller 51 presses the web 13 against the smooth outer surface of belt 41. This causes the web 13 to adhere to the smooth belt 41. This is due in part to the greater surface area of the web 13 in contact with smooth belt 41 relative to textured rollers 51. This is also due to the adhesion forces due to the moisture content in the web 13 and the phenomenon of a wet, sheet-like article more strongly adhering to a smooth surface relative to a textured, rough surface.

The tucking blades 49 are synchronous with the gripping assemblies 61 so that the tucking blades rotate on the shaft 47 and contact the web 13 to tuck same in between the noses 64 of the gripping heads 63. The gripping heads 63 are separated from each other during their travel around pulley 56. As the blade 49 travels around its circular travel path defined by shaft 47, blade 49 moves between the gripping noses 64 while they are separate and also traveling in a circular path around their corresponding pulley 56. As the blade 49 continues to travel along its circular path, it is removed from between the noses 64 as the noses are closing due to their transition from the circular path around pulley 56 and onto a linear travel path intermediate the pulleys 56, 57. In an embodiment, the portion 13A of the web 13 tucked into the gripping assembly 61 does not contain the perforations created by drums 33. With the web 13 tucked into the closed gripping assembly 61, the gripping assembly 61 causes this portion of the web 13 to travel along a path defined by the belt 55, which supports the gripping assemblies 61. Once the web 13 and gripping assembly 61 reaches the top portion of stack 15 on support table 71, the gripping assembly 61 transitions from the linear travel path to a curved travel path defined by lower pulley 57. Accordingly, the gripping noses 64 move apart, the gripping assembly 61 opens, and the web 13 is released at one edge of the table 71. The portion that is tucked into the gripping assembly 61, creates one folded edge of the stack 15. Throughout the operation, the textured rollers 51 continuously urge the web 13 against the smooth belt 41. However, the web 13 is pulled off of the belt 41 due to the gripping force of gripping assembly 61 and tensile strength of the web 13 being greater than the adhesion force of the web 13 on belt 41. When the gripping assembly 61 releases its grip on the web 13, web 13 will continue to adhere to the inner belt segment 42A. That is, the adhesion force of the web 13 on belt 41 is greater than the inertia of the web traveling in the direction of the gripping assemblies. Thus, the web 13 now follows the path of inner belt segment 42A. The inner belt segment 42A carries the web 13 to the other edge of the stack 15. The other edge of the stack 15 is on the opposite side of the stack 15 that was created by the gripping assembly 61. When the web 13 is on the belt 41 and at this other edge of the stack 15, a gripping assembly 61 is again aligned with blade 49 such that gripping assembly 61 grips the web 13 and prevents it from traveling further with belt 41 around lower pulley 44. This begins the process of folding the web 13 again. In an embodiment, the perforation is at the other edge of the stack 15. In a preferred embodiment of the invention, the gripping assembly 61 grips the web 13 at about half the length of an individual sheet as defined as the length of web 13 between perforations minus the length of the web 13 held in the gripping assembly 61.

In operation, the folding apparatus of the present invention unwound, moistened, perforated, and folded a web into a stack at speeds of up to 375 sheets per minute. It is within the scope of the present invention to operate the present invention at speed greater than 375 sheets per minute. In an embodiment, the present invention folds a web into a stack at speeds of up to about 500 sheets per minute. In an embodiment, the folding apparatus folds a web at speeds of 3,000 inches per minute. In an embodiment, the folding apparatus folds a web at speeds of 4,000 inches per minute. In an embodiment, the folding apparatus folds a web at speed in a range of 2,500 to 4,000 inches per minute.

Although specific embodiments have been illustrated and described herein, it will be appreciated by those of ordinary skill in the art that any arrangement, which is calculated to achieve the same purpose, may be substituted for the specific embodiments shown. Many adaptations of the invention will be apparent to those of ordinary skill in the art. For example, other integrated circuit processing equipment may be utilized in conjunction with the invention. Accordingly, this application is intended to cover any adaptations or variations of the invention. It is manifestly intended that this invention be limited only by the following claims and equivalents thereof.

What is claimed is:

1. A folding apparatus for creating a stack of web material, comprising:
a first belt to which a web is releasably adhered, the first belt moving the web to a first side of the stack;
a first pair of pulleys;
a second belt on the first pair of pulleys;
a gripper on the second belt, the gripper periodically gripping the web and moving the web to a second side of the stack.

2. The folding apparatus of claim 1, wherein the gripper opens at one of the first pair of pulleys.

3. The folding apparatus of claim 2, wherein the web includes a non-perforated area and the gripper grips the web in the non-perforated area.

4. The folding apparatus of claim 1, wherein the first belt includes a smooth surface in contact with one side of the web, and wherein an upstream one of the first pair of pulleys includes a textured roller pressing the web against the smooth surface of the first belt.

5. A folding apparatus for folding a web into a stack of web material, comprising:
a first folding unit including a first pulley, a second pulley and a first belt supported by the first pulley and the second pulley, the smooth belt including a smooth surface releasably supporting the web and moving the web to a first fold of the stack; and
a second folding unit including a third pulley, a fourth pulley, a second belt supported by the third pulley and the fourth pulley, and a gripping assembly on the second belt, the gripping assembly periodically gripping the web and moving the web to a second fold of the stack.

6. The apparatus of claim 5, wherein the gripping assembly opens as it travels around the third pulley and closes as it travels between the third pulley and fourth pulley.

7. The apparatus of claim 6, wherein the first folding unit includes a tucking finger that inserts the web into the gripping assembly when the gripping assembly is open.

8. The apparatus of claim 7, wherein the first folding unit includes a fifth pulley that is in contact with and supports an inner surface of the first belt against the textured roller.

9. The apparatus of claim 8, wherein the fifth pulley is intermediate the first pulley and second pulley, the fifth pulley is adjacent the tucking finger, the fifth pulley is rotatably supported on a rotatable shaft, and the tucking finger is fixed to the shaft.

10. The apparatus of claim 9, wherein the first belt includes a plurality of first belts.

11. The apparatus of claim 10, wherein one tucking finger is positioned intermediate each adjacent pair of the plurality of first belts.

12. The apparatus of claim 5, wherein the second folding unit includes a textured roller pressing the web against the smooth surface of the first belt to adhere the web to the first belt.

13. The apparatus of claim 12, wherein the second folding unit includes a single shaft that rotatably supports the third pulley and supports the textured roller.

14. The folding apparatus of claim 12, wherein the textured roller includes a plurality of textured rollers.

15. The folding apparatus of claim 14, wherein the second belt includes at least two second belts, each belt is positioned between two of the textured rollers.

16. The folding apparatus of claim 15, wherein each of the at least two second belts includes a gripping assembly.

17. The folding apparatus assembly of claim 16, wherein each of the gripping assemblies on the at least two second belts are synchronized and horizontally aligned.

18. The apparatus of claim 5, wherein the gripping assembly grips the web at a location equal to one length of an individual sheet of the web minus the length of material held in the gripping assembly.

19. The apparatus of claim 18, wherein the one length of an individual sheet is a length between perforations in the web.

20. The folding apparatus of claim 5, wherein the web is continuous.

21. The folding apparatus of claim 5, wherein the first belt includes a belt segment that periodically supports the web, wherein the belt segment travels at an angle of about 45 degrees relative to vertical.

22. The folding apparatus of claim 21, wherein the first belt initially contacts a vertically traveling web at the first pulley, and wherein the belt segment is downstream of the first pulley.

23. The folding apparatus of claim 5, wherein the second belt includes a belt segment that travels at an angle of about 45 degrees relative to vertical.

24. A method of folding a wet web, comprising:
releasably adhering the wet web to a belt;
moving a first portion of the wet web to one side of a stack;
gripping a second portion of the wet web off the belt; and
moving the second portion of the wet web to a second side of the stack.

25. The method of claim 24, wherein the steps are repeated in order to stack a continuous web.

26. The method of claim 24, wherein adhering the web includes pressing the web against a smooth surface of the belt.

27. The method of claim 26, wherein pressing the web includes urging the web against the smooth surface of the belt with a textured roller.

28. The method of claim 24, wherein gripping the second portion of the web includes gripping the second portion off the belt.

29. The method of claim 28, wherein gripping includes tucking a portion of the web into a gripping assembly.

30. The method of claim 29, wherein gripping includes providing a gripping assembly on a second belt, opening gripping assembly as the second belt travels in an arcuate path, and closing the gripping assembly as the second belt travels in an essentially linear path.

31. The method of claim 30, wherein moving the second portion of the wet web includes moving the second portion away from the first belt to which the web is releasably adhered.
